(19) United States
(12) Patent Application Publication
(10) Pub. No.: US 2014/0121895 A1
(43) Pub. Date: May 1, 2014

(54) ADD-ON VEHICLE WARNING APPARATUS

(71) Applicant: Neng-Chen YEH, Tainan City (TW)

(72) Inventor: Neng-Chen YEH, Tainan City (TW)

(21) Appl. No.: 13/660,085

(22) Filed: Oct. 25, 2012

(51) Int. Cl. G06F 17/00

(52) U.S. Cl. 701/36

(57) ABSTRACT

An add-on vehicle warning apparatus has at least one add-on load and an inter-control module. The inter-control module has a power pin, a ground pin, a first signal input pin and a second signal input pin respectively connected to a CAN BUS system of a vehicle. The inter-control module can receive a control signal and a DC voltage from the CAN BUS system to activate the add-on load according to the control signal. The warning apparatus of the present invention is connected to the CAN BUS system of the vehicle through only four wires. Therefore, the wire layout of the present invent is simplified and is easy to be installed on the vehicle.

### BACKGROUND OF THE INVENTION

1. Field of the Invention

The present invention relates to a warning apparatus, and more particularly to an add-on vehicle warning apparatus.

2. Description of Related Art

A vehicle has warning lights, such as headlights, turn lights and braking lights which are originally equipped upon production. In addition, a user can equip additional warning devices, such as LEDs or a speaker, on the vehicle. If the vehicle does a braking action or a turning action, the warning devices will be correspondingly activated to alert people.

With reference to FIG. 6, the warning devices 41 are electrically connected to a control system 42 of the vehicle. For example, if the driver turns on a left turn light, a warning device 41 is correspondingly activated by the control system 42 of the vehicle.

In general, the control system is usually mounted at the driver's seat. However, the warning devices 41 are mounted on different positions of the vehicle, such as the top, the two sides or the back of the vehicle. With reference to FIG. 4, each warning device 41 is basically connected to the control system 42 through individual wires 43. If the vehicle is equipped with many warning devices 41 arranged on various positions, a large number of the wires results in complicated wire layout. Furthermore, large vehicles such as a truck and a container car need long wires connected between the control system 42 and the warning devices 41.

In conclusion, the conventional warning devices 41 need a lot of wires 43 to be connected to the control system 42 of the vehicle. The wire layout is complicated and apparently indiscriminate. If a technician wants to check or repair the warning device 41, the technician has to make a great effort to do such actions.

### SUMMARY OF THE INVENTION

With respect to the complicated layout of the conventional warning devices, an objective of the present invention is to provide an add-on vehicle warning apparatus to simplify the wire layout. The warning apparatus of the present invention is connected to the control system of the vehicle in a simplified way.

The warning apparatus is adapted to be connected to a CAN BUS system of a vehicle and comprises at least one add-on load and an inter-control module.

The inter-control module is connected between the at least one add-on load and the CAN BUS system and comprises a communication interface, a controller and a regulator.

The communication interface has a first signal input pin and a second signal input pin respectively connected to the CAN BUS system to receive a control signal from the CAN BUS system.

The controller is connected to the communication interface and the at least one add-on load to receive the control signal and activate the at least one add-on load according to the control signal.

The regulator has a power pin and a ground pin respectively connected to the CAN BUS system to receive a DC voltage and convert the DC voltage to a working voltage for providing the controller and the communication interface.

The inter-control module of the present invention can be mounted on any position of the vehicle. When the CAN BUS system of the vehicle generates a control signal, the controller of the inter-control module then correspondingly activates the add-on load according to the control signal. Hence, the inter-control module acts as an intermediate station between the add-on load and the CAN BUS system of the vehicle.

Remarkably, the inter-control module of the present invention is connected to the CAN BUS system of the vehicle only by four pins including the power pin, the ground pin, the first signal input pin and the second signal input pin, such that the warning apparatus of the present invention can be connected to the CAN BUS system of the vehicle through a small number of wires.

In addition, the wires between the CAN BUS system of the vehicle and the inter-control module can be regarded as a first wire layout. The wires between the inter-control module and the add-on load can be regarded as a second wire layout. The lengths of both the first wire layout and the second wire layout are respectively obviously shorter than that of the conventional wires connected between the control system of the vehicle and the warning devices.

Hence, the wire layout of the present invention is simpler. A technician can easily install the warning apparatus of the present invention on the vehicle. The technician can also effectively do an examining action or a repair action for the warning apparatus of the present invention.

### BRIEF DESCRIPTION OF THE DRAWINGS

FIG. 1 is a circuit block diagram of the warning apparatus of the present invention;

FIG. 2 is a detailed circuit diagram of the add-on load unit of the present invention;

FIG. 3A-3L are partial circuit diagrams in FIG. 2;

FIG. 4 is a detailed circuit diagram of the user control unit of the present invention;

FIG. 5A-5D are partial circuit diagrams in FIG. 4; and

FIG. 6 is a circuit block diagram of the conventional warning devices connected to the control system.

### DETAILED DESCRIPTION OF THE PREFERRED EMBODIMENT

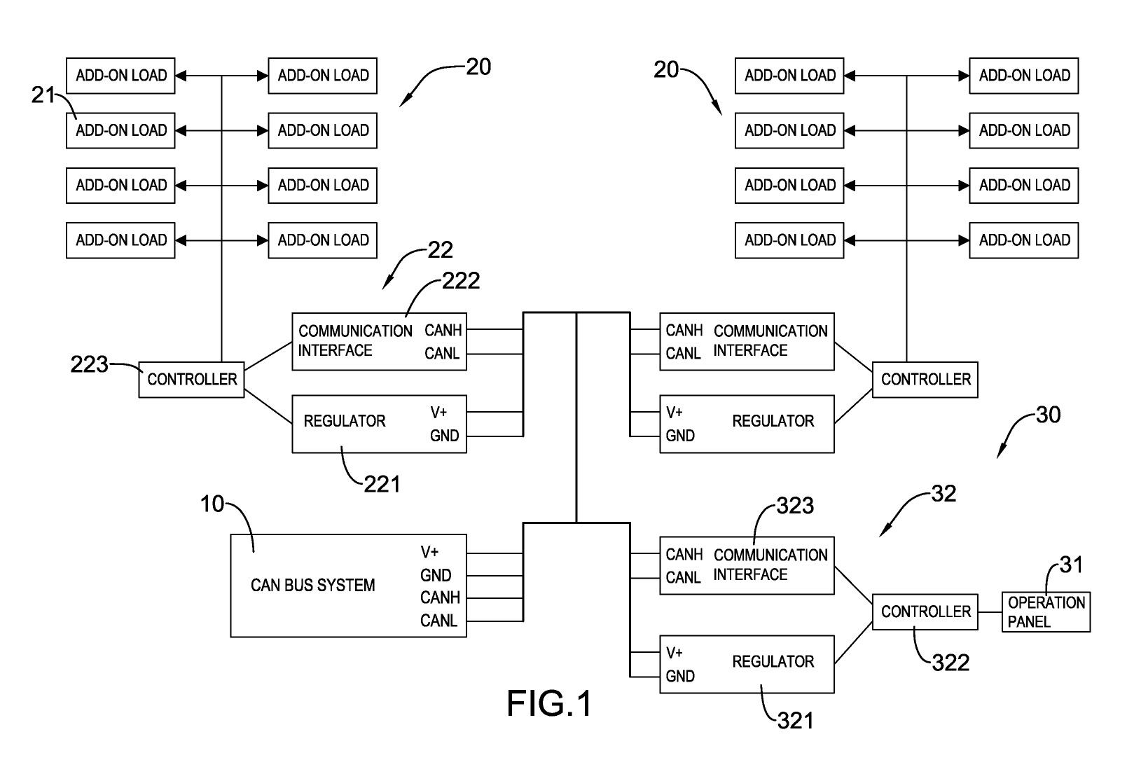

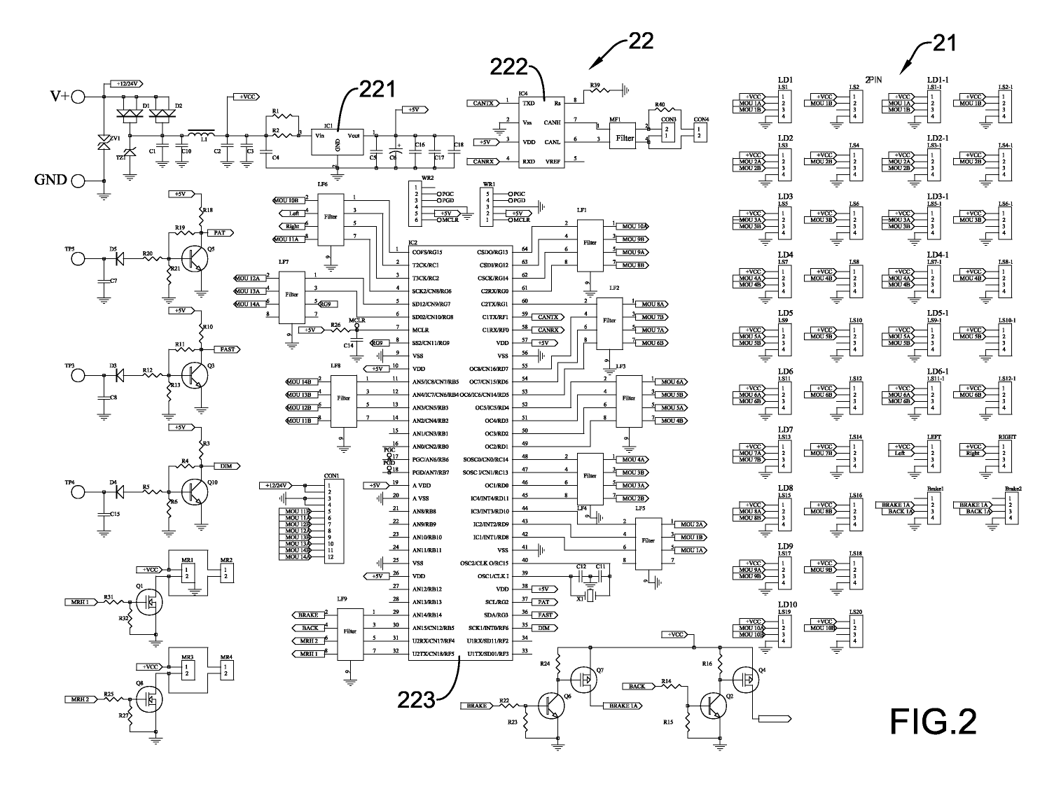

With reference to FIGS. 1, 2, and 3A-3L, the warning apparatus of the present invention is adapted to be electrically connected to a CAN BUS (controller area network bus) system 10 of a vehicle, wherein the CAN BUS system 10 is a control system of the vehicle.

The CAN BUS system 10 comprises a power pin V+, a ground pin GND, a first signal pin CANH and a second signal pin CANL. The CAN BUS system 10 outputs a DC voltage through the power pin V+ and the ground pin GND and outputs a control signal through the first signal pin CANH and the second signal pin CANL, wherein the control signal includes an action code. For example, if the CAN BUS system 10 generates a control signal to turn on a turn light, the turn light will be activated according to the action code of the control signal.

The warning apparatus of the present invention comprises at least one add-on load unit 20. The add-on load unit 20 comprises at least one add-on load 21 and an inter-control module 22.

The add-on load 21 can be a projection lamp, an LED (light emitting diode) lamp or a speaker. The add-on load 21 can be mounted on any position of the vehicle by demand. For example, the add-on load 21 is an LED lamp and is mounted on a left side of the vehicle, such that the LED lamp can be used as a left turn light.

The inter-control module 22 can be a CAN BUS module electrically connected between the add-on load 21 and the CAN BUS system 10. The inter-control module 22 comprises a regulator 221, a communication interface 222 and a controller 223.

The regulator 221 comprises a power pin V+ and a ground pin GND respectively connected to the power pin V+ and the ground pin GND of the CAN BUS system 10. The regulator 221 receives the DC voltage from the CAN BUS system 10 and converts the DC voltage to a working voltage.

The communication interface 222 is electrically connected to the regulator 221 to receive the working voltage. The communication interface 222 has a first signal input pin CANH and a second signal input pin CANL respectively connected to the first signal pin CANH and the second signal pin CANL of the CAN BUS system 10 to receive the control signal.

The controller 223 is electrically connected to the regulator 221, the communication interface 222 and the add-on load 21. The controller 223 receives the working voltage from the regulator 221 and receives the control signal from the communication interface 222. For example, the add-on load 21 is mounted on the vehicle for indicating a braking action. If the CAN BUS system 10 generates a control signal with a braking action code, the controller 223 will receive the control signal. Then, the controller 223 decodes the control signal to obtain the braking action code, such that the controller 223 activates the add-on load 21 according to the braking action code. As a result, an originally equipped braking light of the vehicle and the add-on load 21 are activated at the same time for effectively alerting people.

In conclusion, the inter-control module 22 acts as an intermediate station between the add-on load 21 and the CAN BUS system 10. The inter-control module 22 is adapted to be mounted on any position of the vehicle. The inter-control module 22 is connected to the CAN BUS system 10 of the vehicle through only four wires including two power wires and two signal wires. Therefore, the wire layout between the inter-control module 22 and the CAN BUS system 10 is simplified. A technician can easily recognize the types of the wires to do an examining action or a repair action.

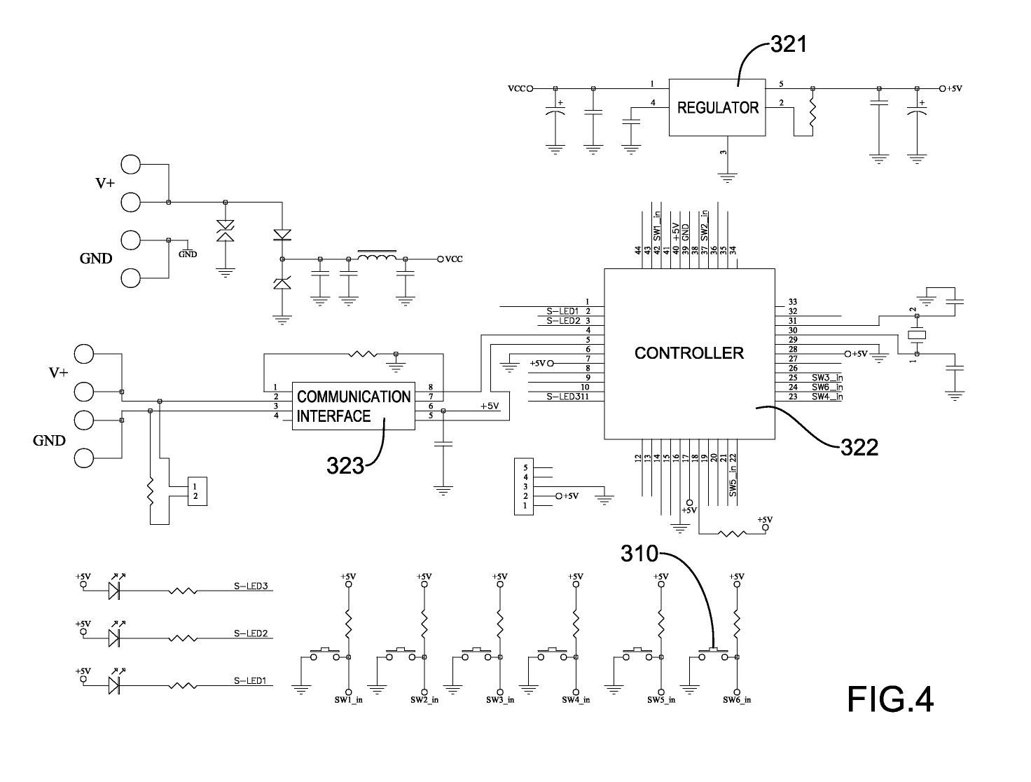

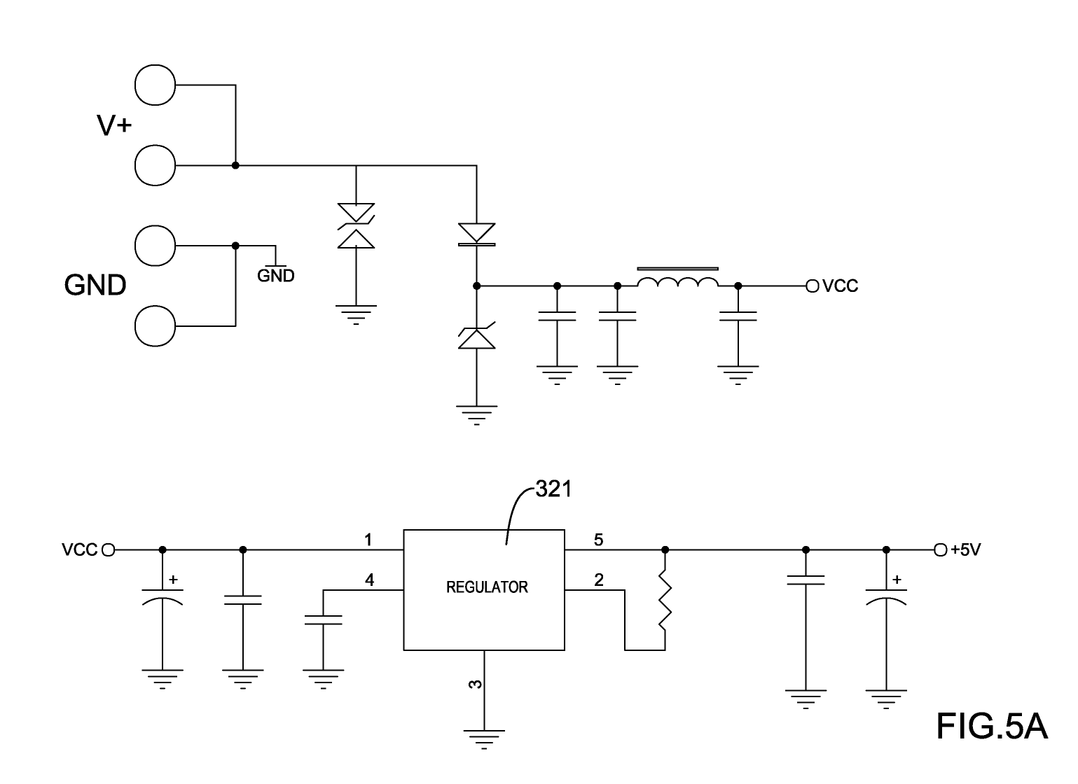

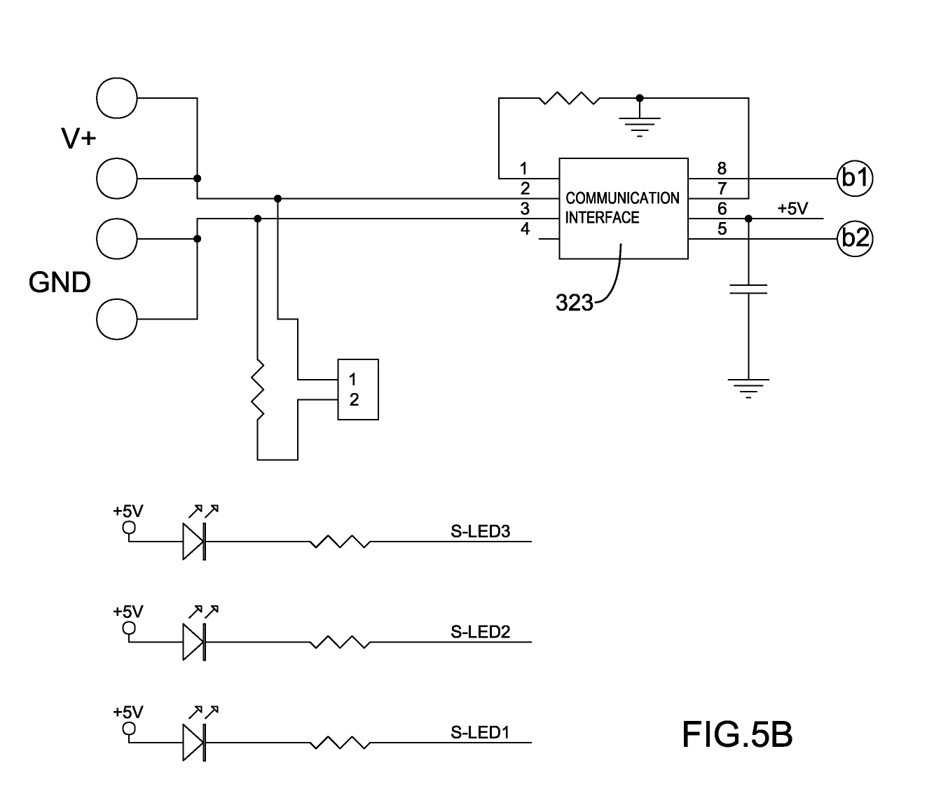

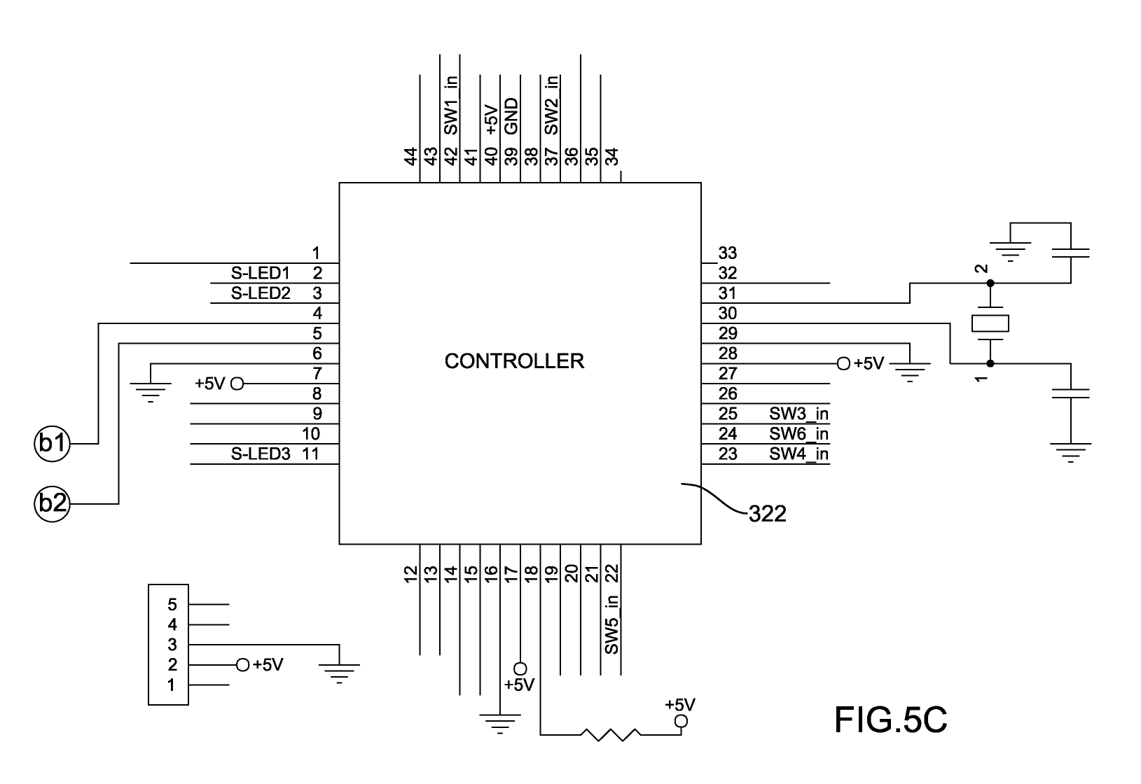

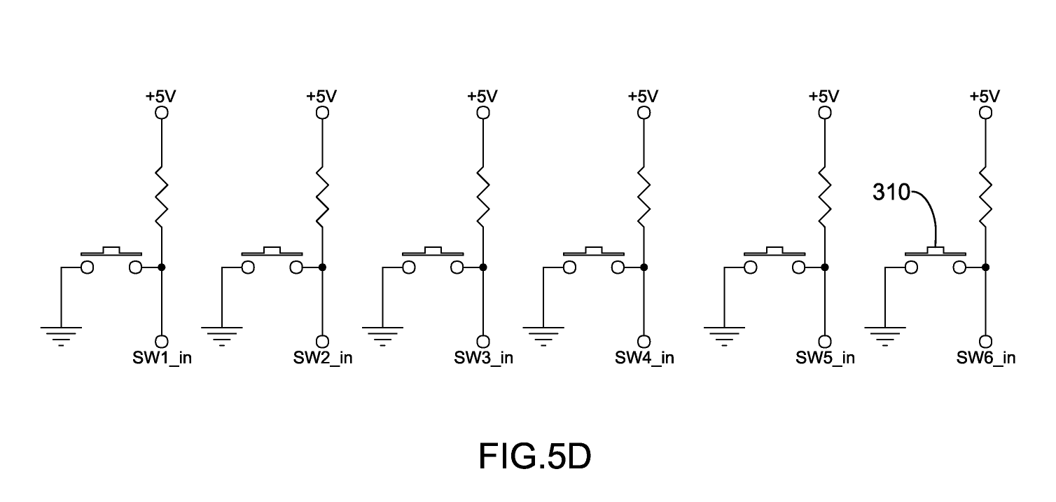

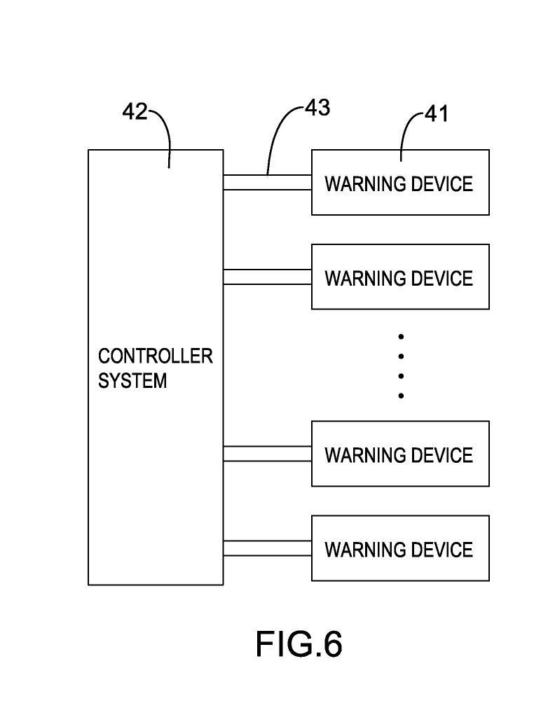

With reference to FIGS. 1, 4 and 5A-5D, the warning apparatus of the present invention further comprises a user control unit 30. The user control unit 30 comprises an operation panel 31 and a user control module 32.

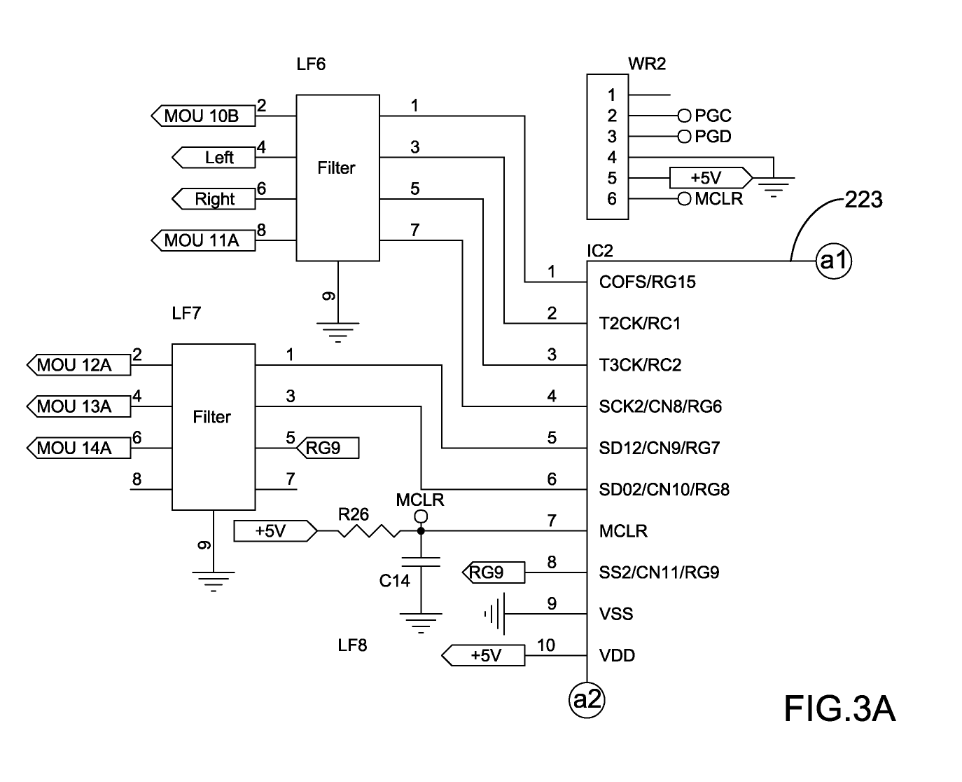

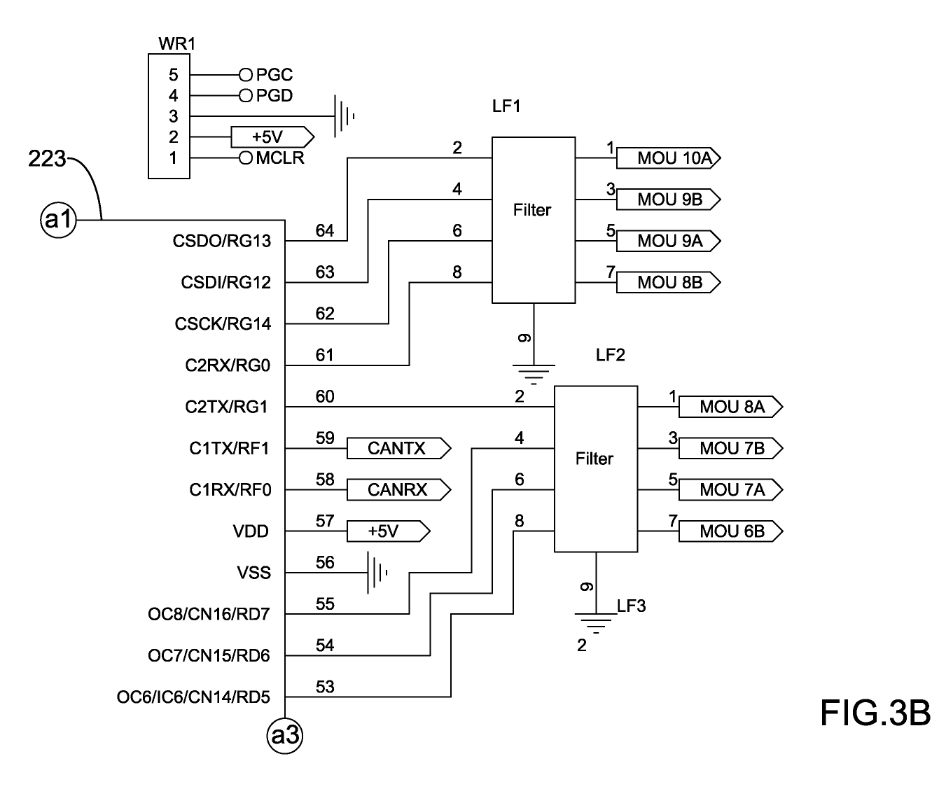

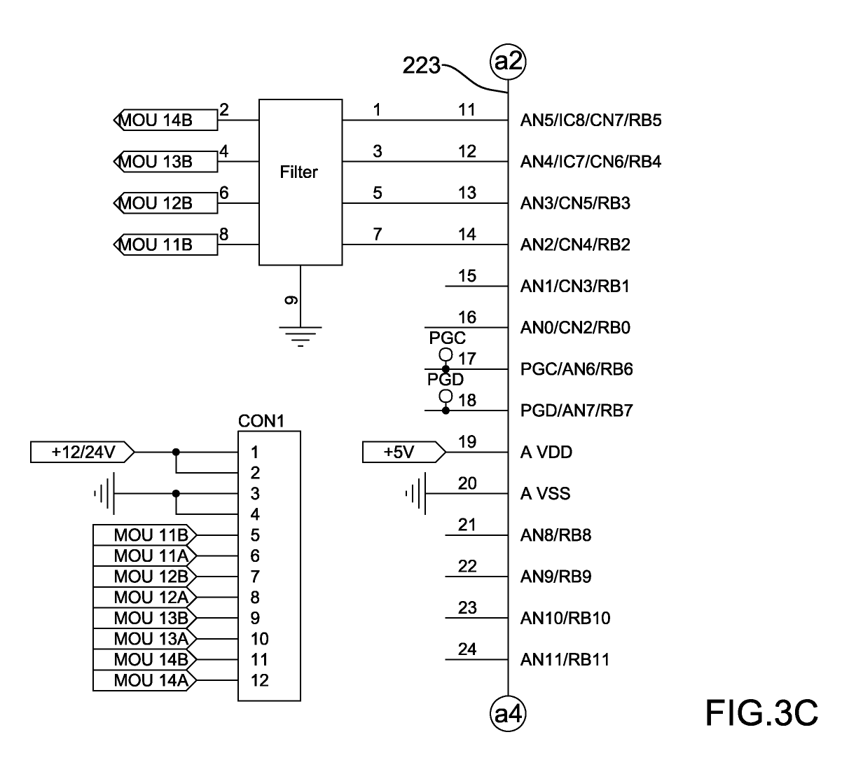

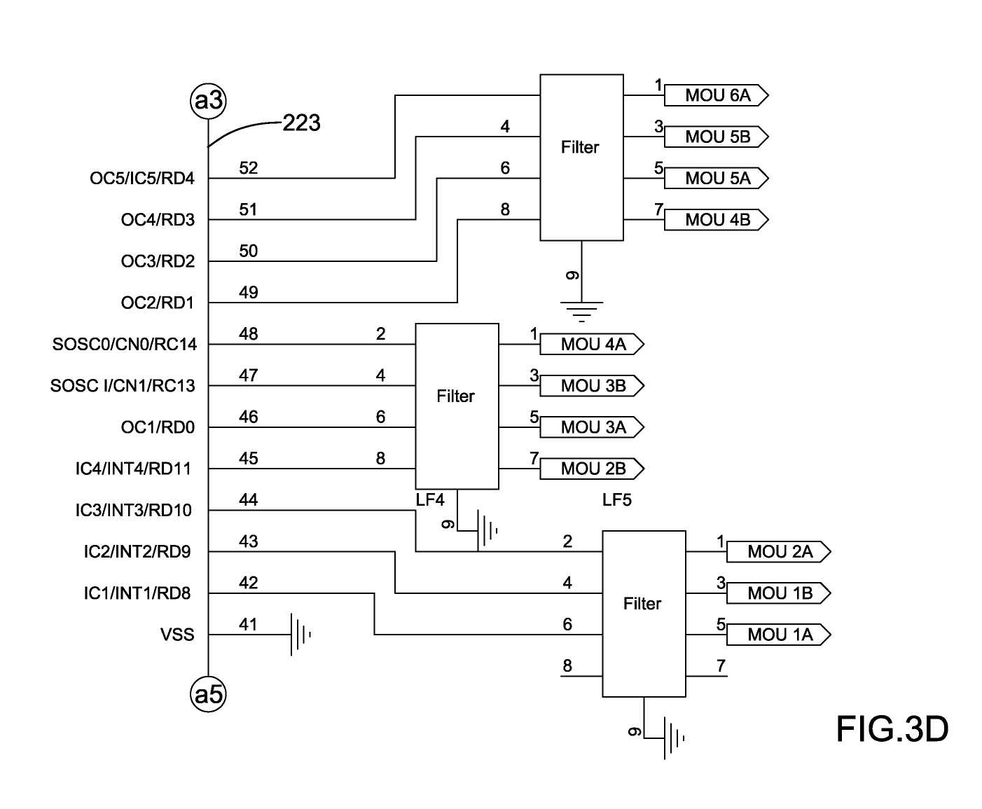

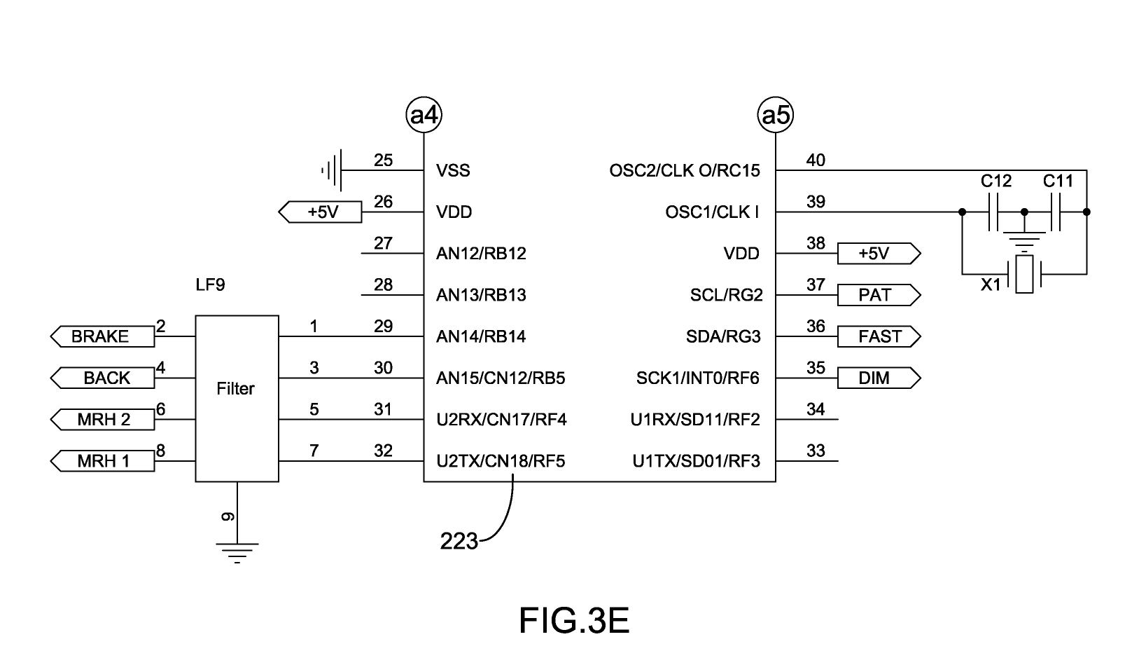

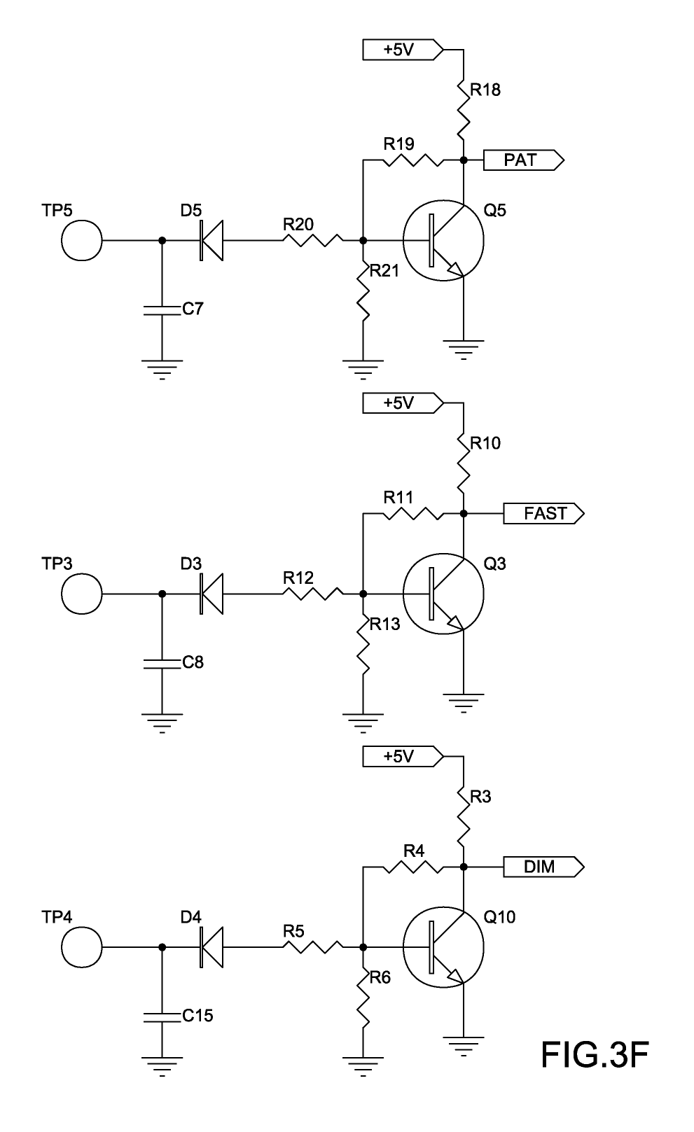

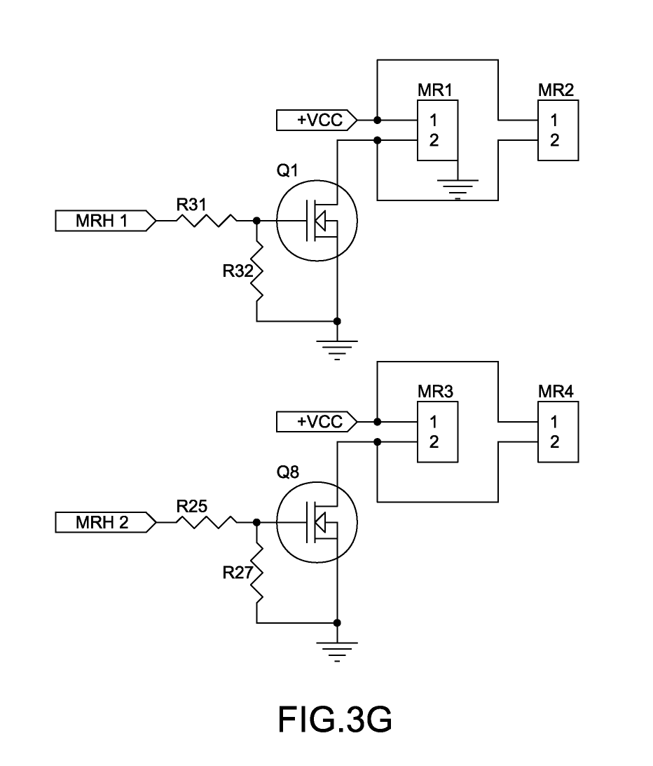

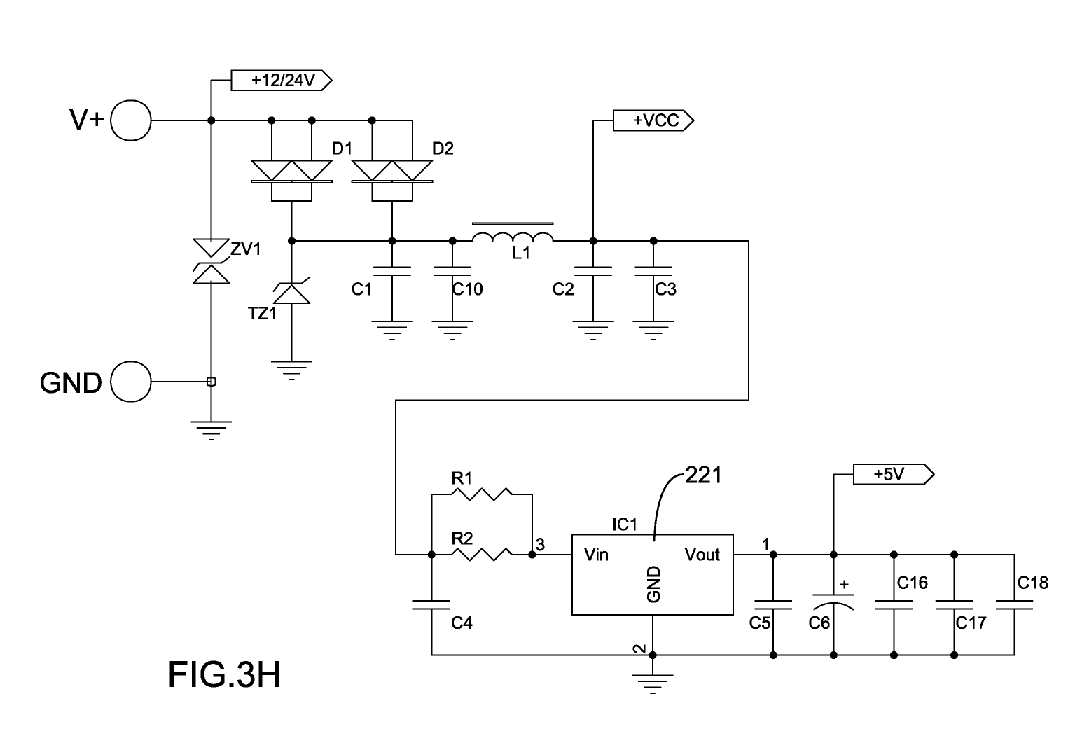

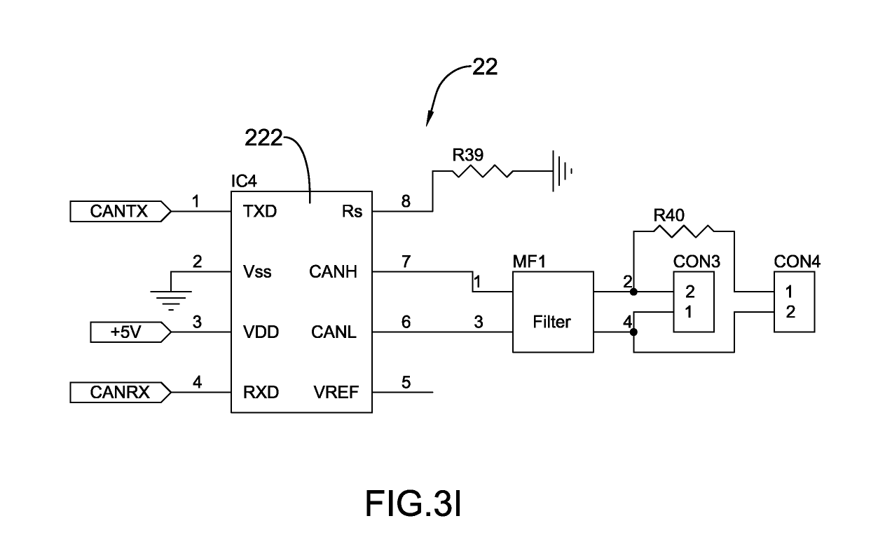

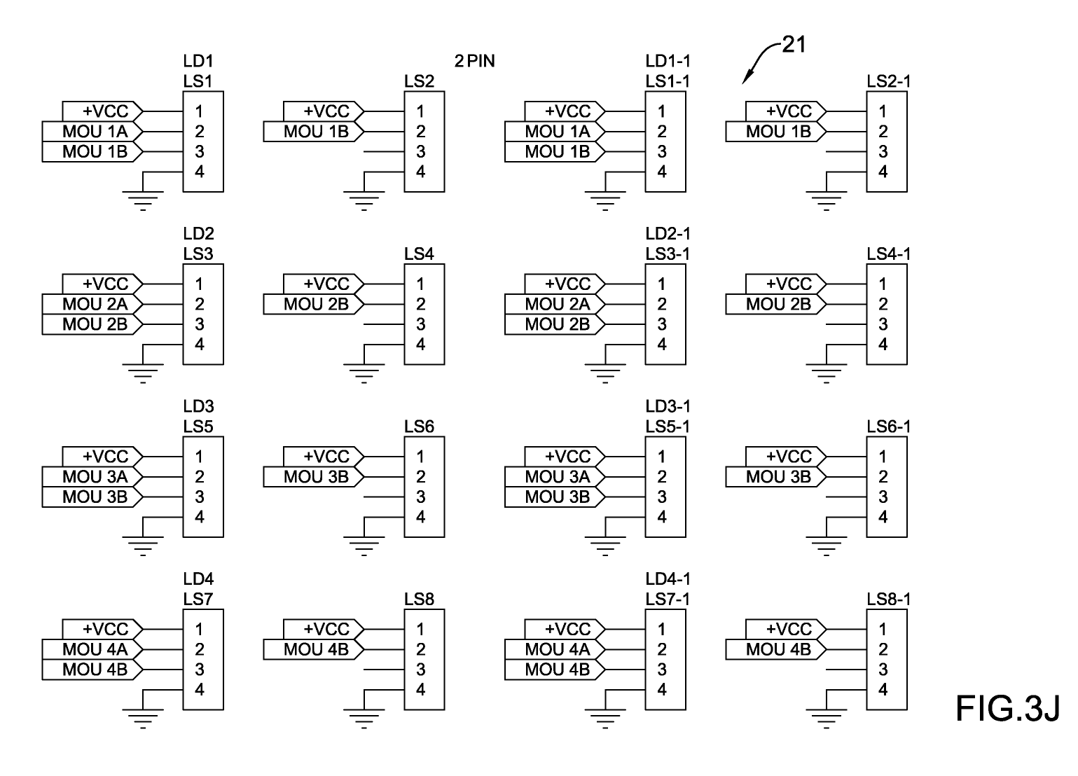

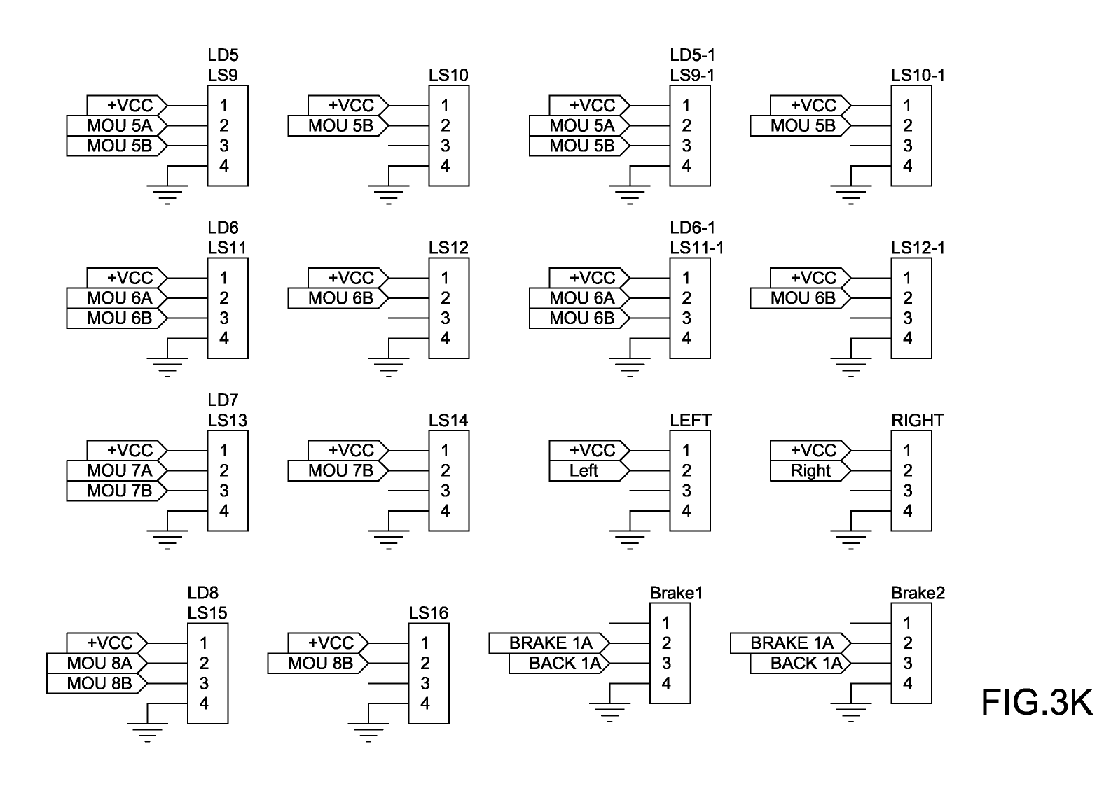

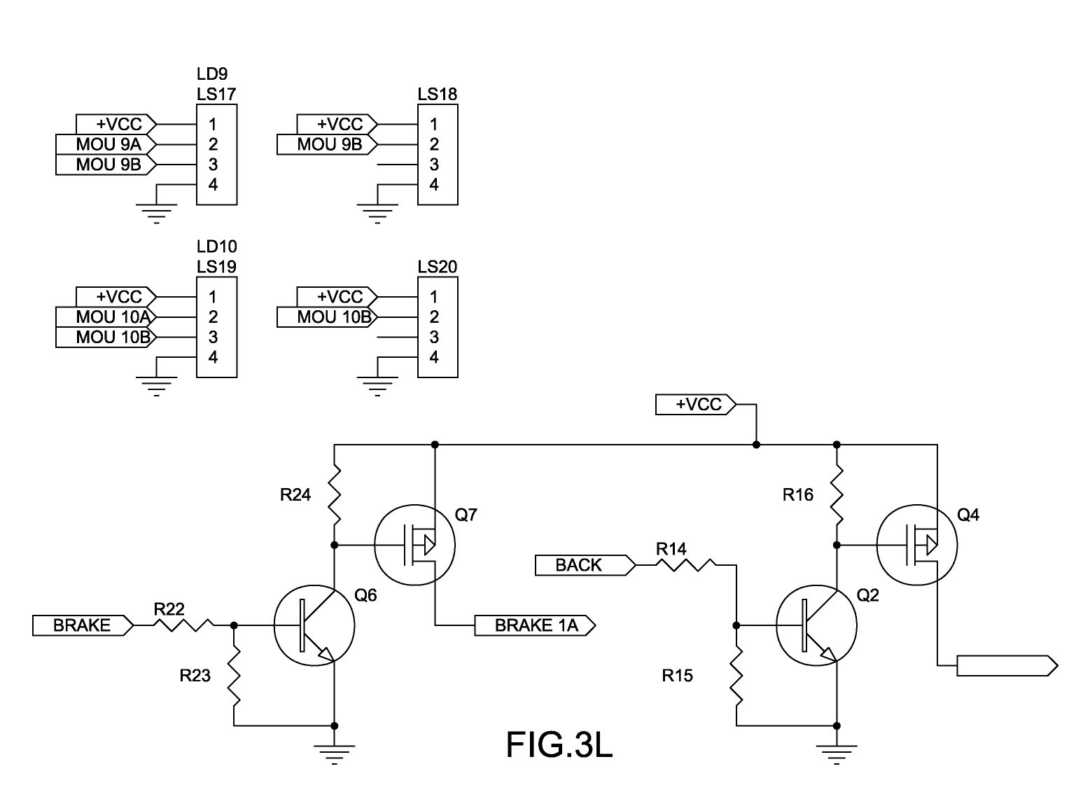

The operation panel 31 is adapted to be mounted in a driver's seat of the vehicle. A user can manually operate the operation panel 31. When the user operates the operation panel 31, the operation panel 31 generates a trigger signal corresponding to an add-on load 21 of the add-on load unit 20. With reference to FIG. 3, the operation panel 31 can have at least one button 310. When the user presses down the button 310, the operation panel 31 generates the trigger signal.

The user control module 32 can be a CAN BUS module and comprises a regulator 321, a controller 322 and a communication interface 323.

The regulator 321 comprises a power pin V+ and a ground pin GND respectively connected to the power pin V+ and the ground pin GND of the CAN BUS system 10. The regulator 221 receives the DC voltage from the CAN BUS system 10 and converts the DC voltage to a working voltage.

The controller 322 is electrically connected to the regulator 321 and the operation panel 31. The controller 322 receives the working voltage from the regulator 321 and receives the trigger signal from the operation panel 31. When the controller 322 obtains the trigger signal, the controller 322 generates a user control signal according to the trigger signal. Because the trigger signal corresponds to a certain add-on load 21, the user control signal generated from the controller 322 is adapted to activate the corresponding add-on load 21.

The communication interface 323 is electrically connected to the regulator 221 to receive the working voltage. The communication interface 323 has a first signal output pin CANH and a second signal output pin CANL respectively connected to the first signal input pin CANH and the second signal input pin CANL of the add-on load unit 20. The communication interface 323 is used to convey the user control signal to the add-on load unit 20.

For example, the add-on load 21 can be a projection lamp. The button 310 of the operation panel 31 is used to correspondingly activate the projection lamp. When the user presses down the button 310, the projection lamp is then activates for illumination of the surroundings.

In this embodiment, the user control unit 30 is connected to the CAN BUS system 10 of the vehicle and the add-on load unit 20 through only four wires including two power wires and two signal wires. The wire layout of the user control unit 30 is as simple as the add-on load unit 20.

Because the inter-control module 22 and the user control module 32 are CAN BUS modules, the CAN BUS module natively has advantages of good signal stability and long communication distance. As a result, the control signals can be effectively conveyed between the add-on load unit 20 and the user control unit 30.

What is claimed is:

1. An add-on vehicle warning apparatus adapted to be connected to a CAN BUS system of a vehicle and comprising:
at least one add-on load; and
an inter-control module connected between the at least one add-on load and the CAN BUS system and comprising:
a communication interface having a first signal input pin and a second signal input pin respectively connected to the CAN BUS system to receive a control signal from the CAN BUS system;
a controller connected to the communication interface and the at least one add-on load to receive the control signal and activate the at least one add-on load according to the control signal; and
a regulator having a power pin and a ground pin respectively connected to the CAN BUS system to receive a DC voltage and convert the DC voltage to a working voltage for providing the controller and the communication interface.

2. The warning apparatus as claimed in claim 1 further comprising:
an operation panel generating a trigger signal; and
a user control module having:
a communication interface having a first signal output pin and a second signal output pin respectively connected to the first signal input pin and the second signal input pin of the inter-control module;
a controller connected to the communication interface of the user control module and the operation panel to receive the trigger signal from the operation panel and generate a user control signal according to the trigger signal for activating the add-on load via the communication interface of the user control module; and
a regulator having a power pin and a ground pin respectively connected to the CAN BUS system to receive the DC voltage and convert the DC voltage to a working voltage for providing the controller and the communication interface of the user control module.

3. The warning apparatus as claimed in claim 2, wherein the inter-control module and the user control module are CAN BUS modules.

4. The warning apparatus as claimed in claim 1, wherein the controller of the inter-control module decodes the control signal to obtain an action code to activate the add-on load according to the action code.

5. The warning apparatus as claimed in claim 2, wherein the controller of the inter-control module decodes the control signal to obtain an action code to activate the add-on load according to the action code.

6. The warning apparatus as claimed in claim 3, wherein the controller of the inter-control module decodes the control signal to obtain an action code to activate the add-on load according to the action code.

7. The warning apparatus as claimed in claim 2, wherein the operation panel has at least one button for generating the trigger signal.

8. The warning apparatus as claimed in claim 3, wherein the operation panel has at least one button for generating the trigger signal.

9. The warning apparatus as claimed in claim 1, wherein the add-on load is an LED lamp.

10. The warning apparatus as claimed in claim 2, wherein the add-on load is an LED lamp.

11. The warning apparatus as claimed in claim 3, wherein the add-on load is an LED lamp.

12. The warning apparatus as claimed in claim 4, wherein the add-on load is an LED lamp.

13. The warning apparatus as claimed in claim 5, wherein the add-on load is an LED lamp.

14. The warning apparatus as claimed in claim 6, wherein the add-on load is an LED lamp.

15. The warning apparatus as claimed in claim 1, wherein the add-on load is a speaker.

16. The warning apparatus as claimed in claim 2, wherein the add-on load is a speaker.

17. The warning apparatus as claimed in claim 3, wherein the add-on load is a speaker.

18. The warning apparatus as claimed in claim 4, wherein the add-on load is a speaker.

19. The warning apparatus as claimed in claim 5, wherein the add-on load is a speaker.

20. The warning apparatus as claimed in claim 6, wherein the add-on load is a speaker.
